(19) United States
(12) Patent Application Publication
(10) Pub. No.: US 2026/0370347 A1
(43) Pub. Date: Nov. 19, 2026

(54) QUANTUM-OPTICS-SUPPORTED TRANSCEIVER SYSTEM

(71) Applicant: UNIVERSITÄT PADERBORN KÖR, Paderborn (DE)

(72) Inventors: Benjamin BRECHT, Paderborn (DE); Christine KNOBLOCH (Genannt Silberhorn), Paderborn (DE); Stephan KRUSE, Paderborn (DE); Laura SERINO, Paderborn (DE)

(21) Appl. No.: 19/477,163

(22) PCT Filed: Apr. 19, 2024
(86) PCT No.: PCT/EP2024/060678

§ 371 Date: Oct. 21, 2025

(30) Foreign Application Priority Data
Apr. 21, 2023 (DE) 10 2023 203 697.5

(51) Int. Cl. H04B 10/70; H04B 10/40

(52) U.S. Cl. CPC H04B 10/70; H04B 10/40

(57) ABSTRACT

The invention relates to a quantum-optically supported transmitting/receiving system comprising
a first transmitting unit set up to deliver signals based on a first laser signal,
a first receiving unit for receiving an optical input signal based on a backscattered signal from the first transmitting unit,
a second combinator, wherein a signal is routed based on the optical input signal and the modulated first laser signal, and a second laser signal is routed to the second combinator, wherein the second laser signal is pulsed,
a first evaluation unit which evaluates the output signal of the second combinator.

### BACKGROUND

In many areas of technology, the precision of measurements is limited by noise as well as by the sampling rates of the analog-to-digital converters used.

One example is a lidar system, which is known for example from the article “Super-resolution technique for CW lidar using Fourier transform reordering and Richardson-Lucy deconvolution” by the authors Joel F. Campbell, Bing Lin, Amin R. Nehrir, F. Wallace Harrison and Michael D, Obland, published in Opt. Lett. 39, pages 6981-6984 (2014). In the knowledge of the limitations, an attempt is made here to compensate for this limitation by means of reworking.

It should be noted that the compensation of the limitations of analogue-to-digital converters involves enormous computational effort. In addition to the associated energy requirements, however, it should also be noted that real-time capability can be lost if there is insufficient computing power, which is usually an exclusion criterion.

Another approach to address the previous drawbacks is to use quantum-entangled states of light. Examples of this can be found in the article “Entangled Fock states for Robust Quantum Optical Metrology, Imaging, and Sensing” by the authors Sean D. Huver, Christoph F. Wildfeuer, Jonathan P. Dowling, published in Phys. Rev. A 78, 063828 (2008), in which a quantum optical system for measurement applications is theoretically considered. Entangled photons are used for the measurement. From the article “Quantum and non-local effects offer over 40 dB noise resilience advantage towards quantum lidar” by the authors Blakey, P.S., Liu, H., Papangelakis, G. et al. published in Nat Commun 13, 5633 (2022). https://doi.org/10.1038/s41467-022-33376-9, a quantum-assisted lidar system is known that uses entangled photons. As a result, the SNR could be improved over 40 dB.

Furthermore, from the article “Enhancing LIDAR performance metrics using continuous-wave photon-pair sources” by the authors Han Liu, Daniel Giovannini, Haoyu He, Duncan England, Benjamin J. Sussman, Bhashyam Balaji, Amr S. Helmy, published in Optica 6, 1349-1355 (2019), a quantum lidar system is known that uses a continuous stream of photon pairs for the realisation of a lidar system.

However, the use of quantum-entangled states of light is not without problems, as these states are very sensitive to losses and are also difficult to generate, such as e.g. from the article “Super-resolving quantum lidar: entangled coherent-state sources with binary outcome photon counting measurement suffice to beat the shot-noise limit” by the authors Qiang Wang, Lili Hao, Yong Zhang, Lu Xu, Chenghua Yang, Xu Yang, and Yuan Zhao, published in Opt. Express 24, 5045-5056 (2016).

Against this background, it is a problem of the invention to provide a transmitting/receiving system that offers an improvement over previous systems without requiring a computationally intensive reconstruction of the original signal or requiring sensitive and thus expensive systems for the generation of non-classical light.

### BRIEF DESCRIPTION OF THE INVENTION

According to the invention, the solution of the problem is achieved by the features of the independent claim. Advantageous embodiments of the invention are specified in the subclaims.

In the following, the invention is explained in greater detail by reference to the appended drawing on the basis of preferred embodiments.

It shows

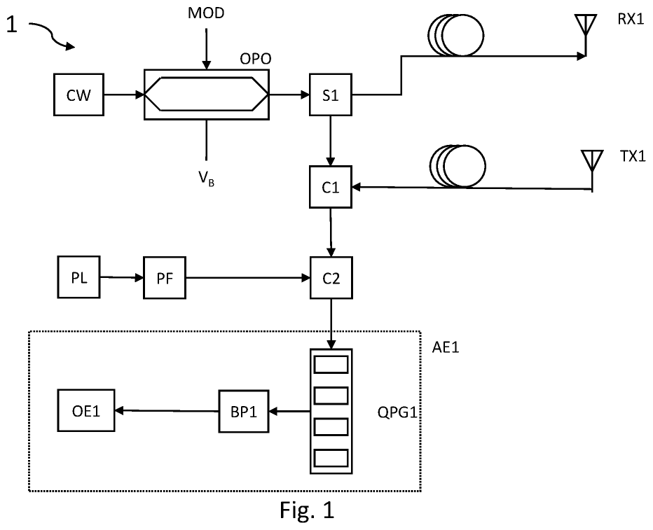

FIGS. 1-7 exemplary embodiments of the invention.

### DETAILED DESCRIPTION OF THE INVENTION IN RELATION TO THE DRAWINGS

In the following, the invention will be described in greater detail by reference to the figures.

It should be noted that different aspects are described, each of which can be used individually or in combination. This means that any aspect can be used with different embodiments of the invention, unless explicitly presented as a pure alternative.

Furthermore, for the sake of simplicity, only one entity will usually be referred to below. Unless explicitly stated, however, the invention may also contain several of the affected entities. In this respect, the use of the word “a” is only to be understood as an indication that at least one entity is used in a single embodiment.

Insofar as methods are described below, the individual steps of a method can be arranged and/or combined in any order, unless something different explicitly emerges from context. Furthermore, the methods can be combined with each other-unless expressly indicated otherwise.

Specifications with numerical values are usually not to be understood as exact values, but also include a tolerance of +/−1% to +/−10%.

Reference to standards or specifications or norms are to be understood as a reference to standards or specifications or norms which are/were also in force at the time of the application and/or—to the extent that priority is claimed—also at the time of the priority application. However, this is not to be understood as a general exclusion of applicability to subsequent or superseding standards or specifications or norms.

In each of the figures, an embodiment of an invention-based quantum-optically supported transmitting/receiving system 1 is shown as an example. A quantum-optically supported transmitting/receiving system 1 according to the invention comprises a first transmitting unit TX1 set up to emit signals based on a first laser signal and a first receiving unit RX1 for receiving an optical input signal based on a backscattered signal from the first transmitting unit TX1.

Furthermore, quantum optically supported transmitting/receiving system 1 according to the invention comprises a second combinator C2, wherein a signal based on the optical input signal and the modulated first laser signal and a second laser signal is routed to the second combinator, wherein the second laser signal is pulsed.

In addition, quantum optically supported transmitting/receiving system 1 according to the invention comprises a first evaluation unit AE1, which evaluates the output signal of the second combinator C2.

The invention thus allows, for example, a lidar system to be implemented, the resolving power of which is limited only by quantum noise. By avoiding any analog-to-digital converters in an HF path, as well as emitting classical light instead of quantum-entangled states, the invention allows several problems in the prior art to be avoided whilst at the same time improving the system parameters compared to previous transmitting/receiving systems.

In embodiments of the invention, furthermore, a first splitter S1 can be provided for splitting an incoming laser signal into a first arm and into a second arm, wherein the first transmitting unit TX1 is arranged in the first arm and is set up for emitting signals based on the modulated first laser signal. Furthermore, quantum-optically supported transmitting/receiving system 1 according to the invention can comprise a first combinator C1, wherein the optical input signal and the modulated first laser signal of the second arm are routed to first combinator C1, wherein the output signal of a first combinator C1 and a second laser signal are routed to a second combinator C2, wherein the second laser signal is pulsed.

It should be noted that, instead of a combinator, other implementations are also possible. As an example, it should be mentioned that the (first) combinator can also be provided by coupling signals from two sources from different directions into the waveguide, so that the signals in the waveguide converge with each other, but also by light being coupled at opposite angles.

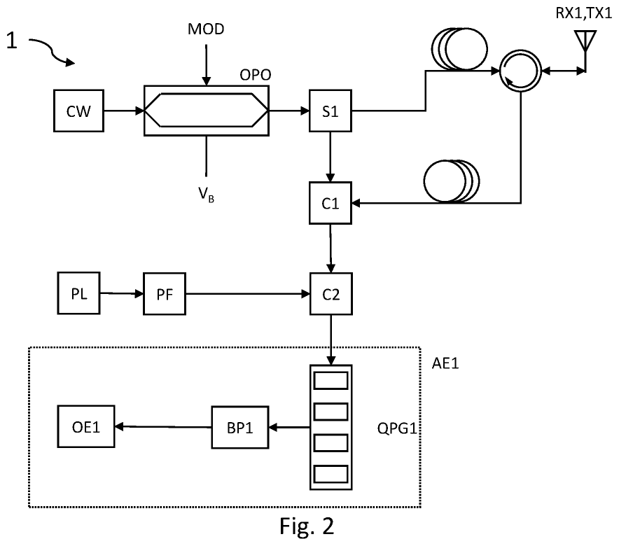

In an embodiment of the invention, quantum-optically supported transmitting/receiving system 1 further comprises a first combinator C1, wherein the optical input signal and the modulated first laser signal are routed to the first combinator C1, wherein the first transmitting unit TX1 and the first receiving unit RX1 are provided in a common unit, wherein furthermore a first circulator Z (see FIGS. 2, 3, 5 and 7) are provided, so that the modulated first laser signal can be routed to the first transmitting unit TX1, whilst the optical input signal can be sent to the first combinator C1.

According to a further embodiment of the invention (see FIGS. 1 and 2), transmitting/receiving system 1 comprises a first laser source CW and a second laser source PL, wherein the second laser source PL comprises a pulsed laser and a pulse former PF.

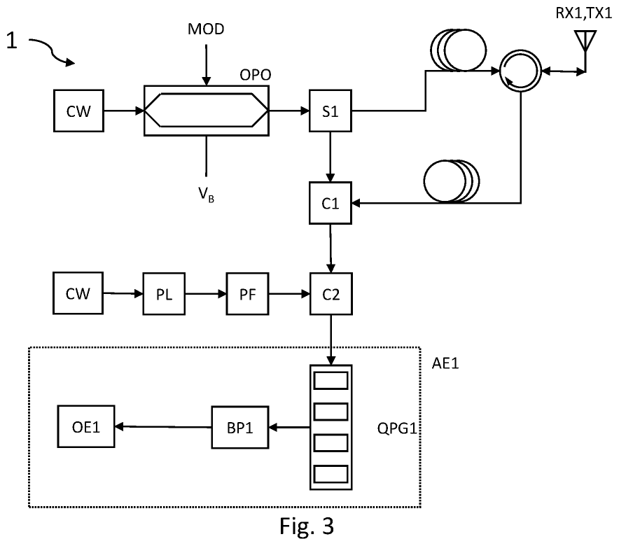

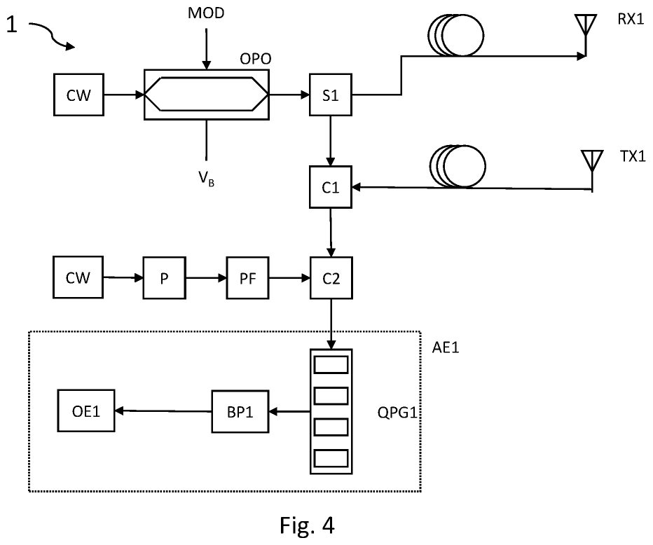

According to yet another embodiment of the invention (see FIGS. 3 and 4), transmitting/receiving system 1 comprises a first laser source CW and a second laser source PL, wherein the second laser source PL comprises a continuous laser CW, a pulser P and a pulse former PF.

In another embodiment of the invention, a laser signal is obtained in quantum-optically supported transmitting/receiving system 1 by manipulation of the second laser signal.

In yet another embodiment of the invention, the first evaluation unit AE1 comprises a first quantum pulse gate QPG1 and a first optoelectronic transducer unit OE1.

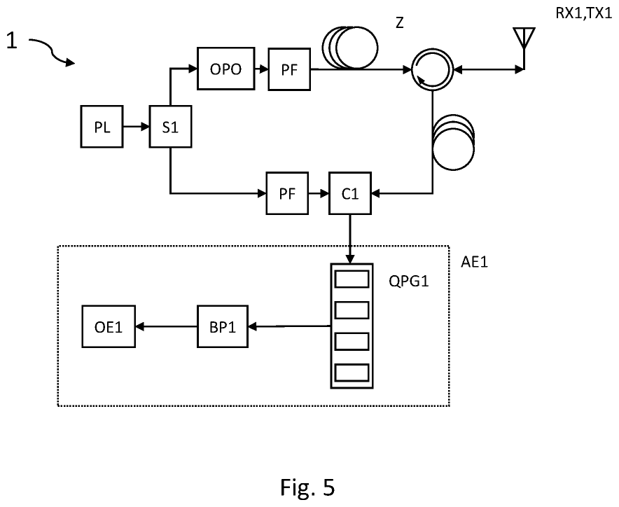

In a further embodiment of the invention (see FIG. 5), the first quantum pulse gate QPG1 is a multi-output quantum pulse gate and the first optoelectronic transducer unit OE1 is a spectrograph.

Optionally-as shown in FIG. 5—provision can also be such that only light from a source PL is used, which is first supplied to a splitter S1. The one arm is then guided to a modulation MO by an exemplary optical-parametric oscillator OPO (and a further optional pulse former), whilst the other arm is guided to a pulse shaper PF. It should be noted that, in the same way as in FIGS. 1-4, embodiments with separate transmitting units TX1 and receiving units RX1 or common units can be provided, wherein an exemplary circulator Z can be used for better isolation of the signal paths.

In yet another embodiment of the invention, the first quantum pulse gate QPG comprises a periodic-polarised nonlinear waveguide, in particular a periodic-polarised lithium niobate or a periodic-polarised potassium titanyl phosphate waveguide.

According to a further embodiment of the invention, the first evaluation unit AE1 has a first optical bandpass filter BP1.

Without limiting the generality of the invention, the first transmitting unit TX1 can have a signal conversion into a transverse wave in a quantum-optically supported transmitting/receiving system 1, and the first receiving unit RX1 can have a signal conversion of a transverse reflected wave into the optical input signal, and/or the first transmitting unit TX1 can have a signal conversion to a longitudinal wave, and the first receiving unit RX1 can have a signal conversion of a longitudinal reflected wave into the optical input signal, and/or the first transmitting unit TX1 can have a signal conversion into a surface wave, and the first receiving RX1 can have a signal conversion of a surface reflected wave into the optical input signal.

Signals to such different signal conversion units can also be changed simultaneously or alternately by means of suitable equipment.

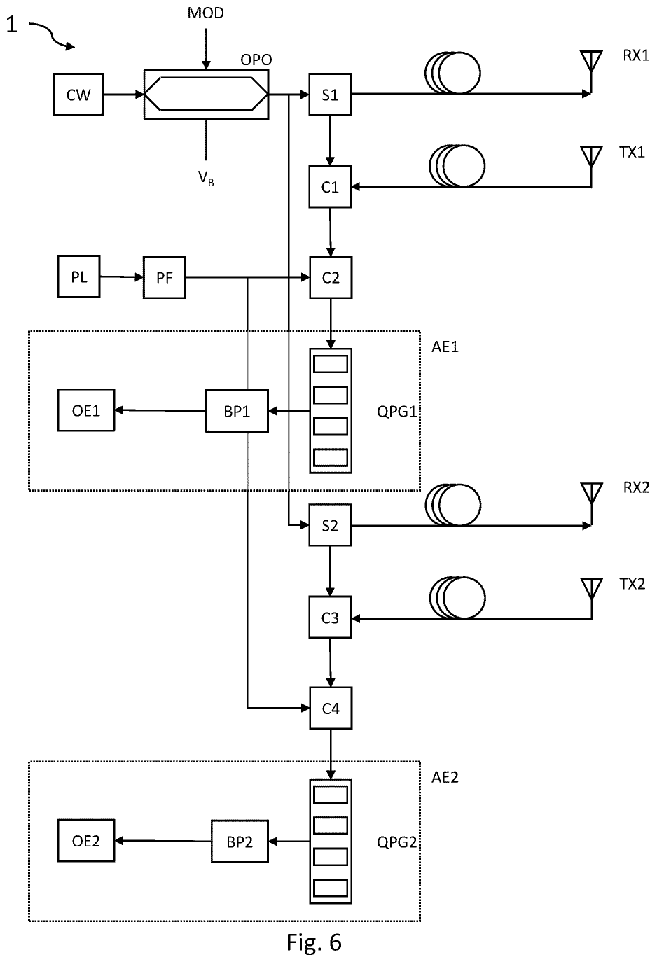

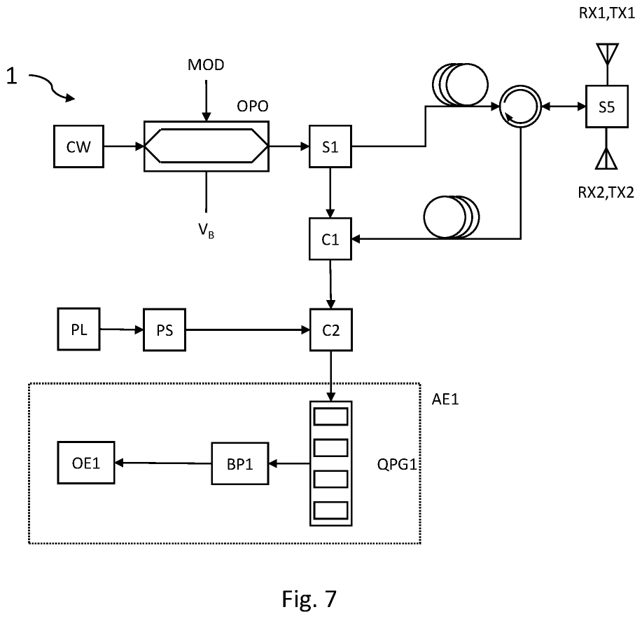

That is to say that in a further embodiment of the invention, at least one further transmitting unit TX2 and a further receiving unit RX2 are also provided, wherein provision can in particular be made such that optical output signals of the further receiving unit RX2 are fed to parallel processing by a second evaluation unit AE2 (see for example FIG. 6) and/or that during operation the first transmitting unit TX1 or the second transmitting unit TX2 are operated separately from each other in time, in particular alternately (see for example FIG. 7). In particular, the second transmitting unit TX2 and the second receiving unit RX2 (as well as other transmitting units/receiving units) can be provided (each) in a common unit (see for example FIG. 7). Furthermore, a second circulator Z can then also be provided (in the case of temporally parallel processing), so that the modulated first laser signal can be routed to the second transmitting unit TX2 and the backscattered signal can be guided in the direction of the second evaluation unit AE2.

According to yet another embodiment of the invention, the second evaluation unit AE2 comprises a second quantum pulse gate QPG2 and a second optoelectronic transducer unit OE2.

In particular, the second quantum pulse gate QPG2 can be designed like the first quantum pulse gate QPG1 and in particular be a multi-output quantum pulse gate and/or the second optoelectronic transducer unit OE2 can be a spectrograph and/or the second quantum pulse gate QPG2 can comprise a periodic-polarised nonlinear waveguide, in particular a periodic-polarised lithium niobate waveguide or a periodic-polarised potassium titanyl phosphate waveguide.

In a further embodiment of the invention, the second evaluation unit AE2 one comprises a second optical bandpass filter BP2.

In a further embodiment of the invention, the second transmitting unit TX2 can have a signal conversion into a transverse wave, and the second receiving unit RX2 can have a signal conversion of a transverse reflected wave into the optical input signal, and/or the second transmitting unit TX2 can have a signal conversion into a longitudinal wave, and the second receiving unit RX2 can have a signal conversion of a longitudinal reflected wave into the optical input signal and/or the second transmitting unit TX2 can have a signal conversion to a surface wave, and the second receiving unit RX2 can have a signal conversion of a reflected wave into the optical input signal.

In yet another embodiment of the invention, the system further comprises a first splitter S1 for splitting an incoming laser signal into a first arm and a second arm, wherein the first transmitting unit TX1 in the first arm is set up for emitting signals based on the modulated first laser signal, and the system further comprises a first combinator C1, where the optical input signal and the modulated first laser signal of the second arm are routed to the first combinator C1.

Without restriction of the generality, splitters as well as combinators can be designed as 3 dB splitters or 3 dB combinators.

In particular, quantum-optically supported transmitting/receiving system 1 according to the invention can be used in a LIDAR system and/or a RaDAR system as well as a combined radar/LiDAR system.

Likewise, the quantum-optically supported transmitting/receiving system 1 according to the invention can be implemented in a group of single input, single output and/or single input, multiple output and/or multiple input, multiple output and/or phased array antennas and/or as a non-fully integrated group (i.e. as a distributed system).

In other words, the invention permits a quantum-optically supported lidar system to implemented, which comprises at least one optical source CW, wherein the light of the optical source CW is distributed to one or more transmitting, receiving and/or transmitting-receiving devices, comprising at least a second optical source PL, whose light is manipulated and merged with a replica of the transmission signal and with the reception signal, and the superposition is fed into a quantum pulse gate QPG, the output signal of which can be evaluated.

Without restricting the generality, light from the source CW can be manipulated directly and/or with an additional element (e.g. an electro-optical modulator), which is controlled by any signal.

In particular, the transmitting unit TX1, TX2 . . . and the receiving unit RX1, RX2 . . . can be implemented as an (external) antenna, which separates a transmitting and receiving signal of any quality.

In particular, the pulsed signal can be merged with the replica of the transmitting and/or receiving signal and/or the superposition of the replica of the transmitting and receiving signal by means of at least one combining 1×N element, wherein N can be any number ≥2.

The detected signal can be proportional to the distance from one and/or more objects.

In particular, one or more harmonics of the arbitrary signal can be generated by the bias voltage VB of an electro-optical modulator

In particular, the optical sources can be designed as lasers.

The detected signal can also be further processed analogue and/or digital

Without restricting the generality, a system according to the invention can be interconnected to a phased group antenna of any aperture and any degree of occupancy.

Furthermore, without restricting the generality, the system can be implemented from discrete components and/or as a partially integrated and/or as a fully integrated solution.

What is claimed is:

1. A quantum-optically supported transmitting/receiving system comprising
a first transmitting unit set up to deliver signals based on a first laser signal,
a first receiving unit for receiving an optical input signal based on a backscattered signal from the first transmitting unit,
a second combinator-wherein a signal based on the optical input signal and the modulated first laser signal is routed to the combinator, and a second laser signal is routed to the second combinator~wherein the second laser signal is pulsed,
a first evaluation unit which evaluates the output signal of the second combinator.

2. The quantum-optically supported transmitting/receiving system according to claim 1, wherein the quantum-optically supported transmitting/receiving system further comprises a first combinator, wherein the optical input signal and the modulated first laser signal are routed to the first combinator, wherein the first transmitting unit and the first receiving unit are provided in a common unit, wherein a first circulator is further provided, so that the modulated first laser signal can be routed to the first transmitting unit, whilst the optical input signal can be sent to the first combinator.

3. The quantum-optically supported transmitting/receiving system according to claim 1, wherein the transmitting/receiving system comprises a first laser source and a second laser source wherein the second laser source comprises a pulsed laser and a pulse former.

4. The quantum-optically supported transmitting/receiving system according to claim 1, wherein it comprises a first laser source and a second laser source wherein the second laser source comprises a continuous laser, a pulser and a pulse former.

5. The quantum-optically supported transmitting/receiving system according to claim 1, wherein the laser signal was obtained by manipulation of the second laser signal.

6. The quantum-optically supported transmitting/receiving system according to claim 1, wherein it comprises a first laser source and a second laser source, wherein the second laser source comprises a continuous laser, and a combination of a pulser and a pulse former.

7. The quantum-optically supported transmitting/receiving system according to claim 1, wherein the first evaluation unit comprise a first quantum pulse gate and a first optoelectronic transducer unit.

8. The quantum-optically supported transmitting/receiving system according to claim 7, wherein the first quantum pulse gate is a multi-output quantum pulse gate and/or the first optoelectronic transducer unit is a spectrograph.

9. The quantum-optically supported transmitting/receiving system according to claim 7, wherein the first quantum pulse gate comprises a periodically polarised nonlinear waveguide.

10. The quantum-optically supported transmitting/receiving system according to claim 7, wherein the first quantum pulse gate comprises a periodically polarised lithium niobate waveguide or a periodically polarised potassium titanyl phosphate waveguide.

11. The quantum-optically supported transmitting/receiving system according to claim 1, wherein the first evaluation unit has a first optical bandpass filter.

12. The quantum-optically supported transmitting/receiving system according to claim 1, wherein either
the first transmitting unit has a signal conversion to a transverse wave, and that the first receiving unit has a signal conversion of a transverse reflected wave into the optical input signal, and/or
the first transmitting unit has a signal conversion into a longitudinal wave, and that the first receiving unit has a signal conversion of a longitudinal reflected wave into the optical input signal, and/or
the first transmitting unit has a signal conversion into a surface wave, and that the first receiving unit has a signal conversion of a surface-reflected wave into the optical input signal.

13. The quantum-optically supported transmitting/receiving system according to claim 1, wherein at least one further transmitting unit and one further receiving unit are also provided.

14. The quantum-optically supported transmitting/receiving system according to claim 13, herein optical output signals of the further receiving unit are fed to parallel processing by a second evaluation unit.

15. The quantum-optically supported transmitting/receiving system according to claim 13, wherein during operation the first transmitting unit or the second transmitting unit are operated separately from each other in time, in particular alternatingly.

16. The quantum-optically supported transmitting/receiving system according to claim 13, wherein the second transmitting unit and the second receiving unit are provided in a common unit, wherein a second circulator is further provided, so that the modulated first laser signal can be routed to the second transmitting unit.

17. The quantum-optically supported transmitting/receiving system according to claim 13, wherein the second evaluation unit comprises a second quantum pulse gate and a second optoelectronic transducer unit.

18. The quantum-optically supported transmitting/receiving system according to claim 17, wherein the second quantum pulse gate is a multi-output quantum pulse gate and the second optoelectronic transducer unit is a spectrograph.

19. The quantum-optically supported transmitting/receiving system according to claim 17, wherein the second quantum pulse gate has a periodically polarised nonlinear waveguide.

20. The quantum-optically supported transmitting/receiving system according to claim 17, wherein the first quantum pulse gate comprises a periodically polarised lithium niobate waveguide or a periodically polarised potassium titanyl phosphate waveguide. (Currently Amended) The quantum-optically supported transmitting/receiving system according to claim 13, wherein the second evaluation unit comprises a second optical bandpass filter.

22. The quantum-optically supported transmitting/receiving system according to claim 13, wherein either
the second transmitting unit has a signal conversion into a transverse wave, and that the second receiving unit has a signal conversion of a transverse reflected wave into the optical input signal, and/or
the second transmitting unit has a signal conversion to a longitudinal wave, and that the second receiving unit has a signal conversion of a longitudinal reflected wave into the optical input signal, and/or
the second transmitting unit has a signal conversion into a surface wave, and that the second receiving unit has a signal conversion of a reflected wave into the optical input signal.

23. The quantum-optically supported transmitting/receiving system according to claim 1, wherein the system further
comprises a first splitter for splitting an incoming laser signal into a first arm and a second arm, wherein
the first transmitting unit in the first arm is set up to deliver signals based on the modulated first laser signal,
and the system further comprises a first combinator, where the optical input signal and the modulated first laser signal of the second arm are routed to the first combinator.

24. Use of a quantum-optically supported transmitting/receiving system according to claim 1 in a LiDAR system.

25. The use of a quantum-optical-supported transmitting/receiving system according to claim 1 in a RaDAR system.

26. The use of a quantum-optically supported transmitting/receiving system according to claim 1 in a combined radar/LiDAR system.

27. The use o a quantum-optically supported transmitting/receiving system according to claim 1, wherein it has been operated and/or implemented a single input single output and/or multiple input single output and/or single input multiple output and/or multiple input multiple output and/or phased array antennas and/or as a distributed system.
